(19) United States
(12) Patent Application Publication
(10) Pub. No.: US 2004/0257563 A1
(43) Pub. Date: Dec. 23, 2004

(54) Dual band hyperspectral imaging spectrometer

(75) Inventors: Harold E. Miller, Westminster, CA (US); Peter J. Jarecke, Manhattan, CA (US)

Correspondence Address: John A. Miller, Warn, Burgess & Hoffmann, P.C., P.O. Box 70098, Rochester Hills, MI, 48307, US

(73) Assignee: Northrop Grumman Corporation, Los Angeles, CA

(21) Appl. No.: 10/465,342

(22) Filed: Jun. 19, 2003

(51) Int. Cl. G01J 3/28

(52) U.S. Cl. 356/328

(57) ABSTRACT

A dual band spectrometer (40) for imaging one or two spectral bands onto a common image plane. The spectrometer (40) includes an input aperture (42) for receiving scene photons; an entrance slit (46) illuminated by photons from the input aperture (42); a diffraction grating (50) for dispersing the photons into spectral bands, such that at least one of the spectral bands embodies two diffraction orders; a collimator (48) for collimating the photons from the input aperture (42) and directing the photons toward the diffraction grating (50); an image plane (60) receiving the at least one spectral component from the diffraction grating (50); and an order sorting filter device (54) interposed between the diffraction grating (50) and the image plane (60), such that the filter device (54) is operable to pass only one of the two diffraction orders onto the image plane (60).

### BACKGROUND OF THE INVENTION

1. Field of the Invention

This invention relates generally to a dual band spectrometer, and, more particularly, to an optical system for imaging two spectral bands onto a common focal plane in the context of a hyperspectral imaging spectrometer.

2. Discussion of the Related Art

Conventional hyperspectral imaging spectrometers commonly employ a dichroic beam splitter to separate incoming light into different wavelength bands for processing by two separate optical subsystems. In other words, conventional spectrometers employ separate imaging optics, potentially separate gratings and separate focal plane assemblies to support different wavelength bands. Because each of the optical subsystems typically require different operating temperatures, conventional spectrometers also use costly and complex thermal management systems for regulating the operational temperature associated with each of the optical subsystems.

Therefore, it is desirable to provide an improved dual band spectrometer for supporting at least two wavelength bands using a common image plane. It is envisioned that the spectrometer is preferably operable in either a mid-wave infrared wavelength band (i.e., 3.5 to 7 microns) or a long-wave infrared wavelength band (i.e., 7 to 14 microns) without the need for two separate focal plane assemblies. In this way, the improved spectrometer saves the cost of employing separate imaging optics, a beam splitter, separate gratings and separate focal plane assemblies. It is further envisioned that the improved spectrometer saves cost by employing only a single thermal management system for regulating the operational temperature associated with the device.

### SUMMARY OF THE INVENTION

In accordance with the provisions of the present invention, a dual band spectrometer is provided for imaging at least two spectral bands onto a common image plane. The spectrometer includes an input aperture for receiving scene photons; a source slit illuminated by photons from the input aperture; a diffraction grating for dispersing the photons into spectral bands, such that at least one of the spectral bands embodies two diffraction orders (e.g., a mid-wave order from 3.5 to 7 microns and a long wave order from 7 to 14 microns); a collimator for collimating the photons from the input aperture and directing the photons toward the diffraction grating; an image plane receiving the at least one spectral component from the diffraction grating; and an order sorting filter device interposed between the diffraction grating and the image plane, such that the filter device is operable to pass only one of the two diffraction orders embodied in the spectral component onto the image plane.

Additional objects, features and advantages of the present invention will become apparent from the following description and appended claims taken in conjunction with the accompanying drawings.

### BRIEF DESCRIPTION OF THE DRAWINGS

FIG. 1 is a block diagram of a conventional dual band spectrometer; and

FIG. 2 is a block diagram of a dual band spectrometer in accordance with the present invention.

### DETAILED DESCRIPTION OF THE PREFERRED EMBODIMENTS

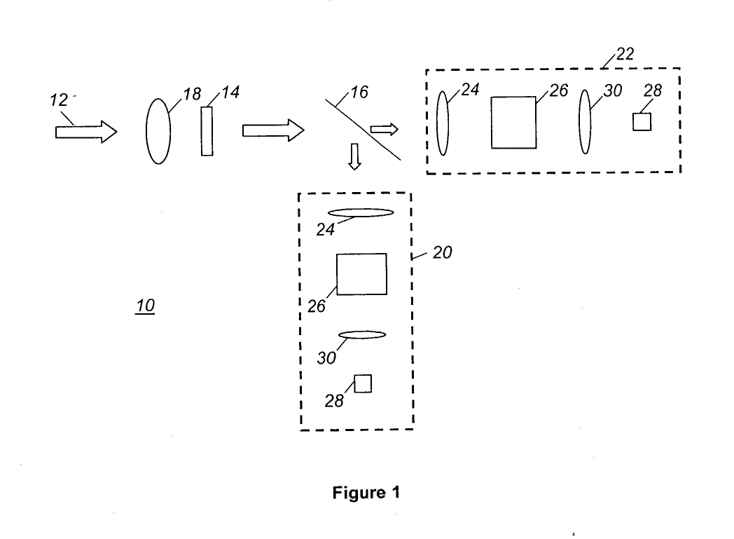

FIG. 1 illustrates the basic optical layout of a conventional dual band spectrometer (10). Incoming infrared scene photons (12) are imaged by foreoptics (18) onto an entrance slit (14) which in turn passes the photons to a dichroic beam splitter (16). The beam splitter (16) is used to separate the photons from the entrance slit (14) into two wavelength bands. A mid-wave infrared band of photons is directed to a mid-wave infrared subsystem (20); whereas a long-wave infrared band of photons is directed to a long-wave infrared subsystem (22).

Each of the mid-wave and long-wave subsystems (20) and (22) are comprised of a collimator (24), a grating (26), and a focal plane assembly (28). The collimator (24) collimates the photons received from the beam splitter (16) and directs them towards a grating (26). The grating (26) disperses the photons received from the collimator prior to passing the photons onto a focal plane assembly (28). Imaging optics (30) may be used to image the photons from the grating (26) onto the focal plane assembly (28). Thus, a conventional spectrometer (10) typically requires separate gratings and separate focal planes for each of the wavelength bands supported by the device. An alternative configuration of the conventional spectrometer system (not shown) uses a single grating and places the beam splitter between the grating and the spectrometer imaging optics. In this case, the spectrometer system uses only one grating but still has two imaging optics and two focal planes.

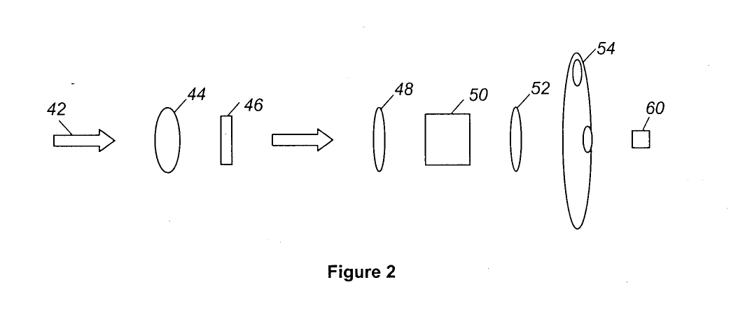

In accordance with the present invention, an optical layout for an improved dual band spectrometer (40) is shown in FIG. 2. Incoming infrared scene photons are received through an input aperture into the spectrometer (40). Fore optics (44) may be used to image the photons onto an entrance slit (46). The entrance slit (46) passes the photons onto a dispersing element (50). A collimator (48) disposed between the entrance slit (46) and the diffraction grating (50) may be used to collimates photons passing through the entrance slit (46).

The dispersing element (50) is used to disperse the photons into at least two spectral bands, such that at least one of the spectral bands embodies two diffraction orders. Specifically, one of the spectral bands includes a first diffraction order covering 7 to 14 microns and a second diffraction order that overlaps the same angular direction as the first diffraction order while covering 3.5 to 7 microns. In a preferred embodiment, a diffraction grating serves as the dispersing element (50). One skilled in the art will readily recognize that such diffraction gratings may be manufactured according to the application specific requirements of line spacing, diffraction angle, wavelength band, efficiency, etc. Exemplary diffraction gratings are commercially available from a variety of sources including Diffraction Products, Inc. of Woodstock, Ill., and Jet Propulsion Laboratories of Pasadena, Calif. It is also envisioned that other types of optical elements may be used to disperse the light in accordance with the present invention.

The spectral component is then directed to and received by a common image plane (60). However, in order to observe one or the other of the two diffraction orders embodied in the one range of diffraction angles, an order sorting filter device (54) is interposed between the diffraction grating (50) and the image plane (60). The order sorting filter device (54) employs two order sorting filters. In operation, a first order sorting filter receives both diffraction orders from the diffraction grating (50) and filters out the second diffraction order (i.e., 3.5-7 microns) while allowing the first order (i.e., 7 to 14 microns) to pass through onto the image plane (60). In contrast, a second order sorting filter performs the opposite task when it is used in place of the first filter so that the second diffraction order is transmitted to the image plane and the first order is blocked or filtered out. In this way, the spectrometer (40) of the present invention is operable in two wavelength bands. Without the use of a filter device (54), photons associated with both diffraction orders would strike at the same spatial position on the image plane (60).

In a preferred embodiment, the dual band spectrometer (40) is operable in either a mid-wave infrared wavelength band or a long-wave infrared wavelength band of light. In a long-wave mode, the order sorting filter device is designed to block all wavelengths less than 7 microns, thereby passing wavelengths in the long-wave infrared band. In a mid-wave mode, the order sorting filter device is designed to block all wavelengths greater than 7 microns, thereby passing wavelengths in the mid-wave infrared band. It is envisioned that the order sorting filter device operates to allow only one waveband to the grating at a time depending on the operation mode of the spectrometer. Thus, the spectrometer of the present invention is operable in a mid-wave infrared wavelength band and a long-wave infrared wavelength band without the need for a separate focal plane.

By designing the spectrometer (40) to operate best in the long-wave infrared band, the mid-wave infrared band can still be fully accommodated on a common image plane. Thus, the diffraction grating is designed for maximum throughput in the 8 to 12.5 micron band while maintaining good performance in the 3.5 to 7 micron band. Various commercially available focal plane assemblies are responsive to wavelengths ranging from 2 microns to at least 14 microns as is well known in the art. Such a focal planes may be composed of Mercury Cadmium telluride material specified for the 2 to 14 micron wavelength range. Exemplary focal planes are commercially available from Rockwell Science Center in California.

The foregoing discussion discloses and describes merely exemplary embodiments of the present invention. One skilled in the art will readily recognize from such discussion, and from the accompanying drawings and claims, that various changes and variations can be made therein without departing from the spirit and scope of the invention as defined in the following claims.

What is claimed is:

1. An optical system for imaging at least two spectral components onto a common image plane, comprising:
an input aperture receiving scene photons;
an image plane;
a dispersing element receiving photons passing through the input aperture, the dispersing element operable to disperse the photons into a plurality of spectral components and to pass one of the spectral components onto the image plane, such that the one spectral component embodies two diffraction order wavelengths and is directed towards a first spatial position on the image plane; and
a sorting filter device interposed between the dispersing element and the image plane, the filter operable to pass only one of the two diffractive order wavelengths onto the image plane.

2. The optical system of claim 1 further comprising an entrance slit and fore optics, the fore optics being interposed between the input aperture source and the entrance slit and operable to image the photons passing through the input aperture onto the entrance slit.

3. The optical system of claim 2 further comprising a collimator that collimates the photons directed to the dispersing element, where the collimator is interposed between the entrance slit and the dispersing element.

4. The optical system of claim 1 wherein the dispersing element is further defined as a diffraction grating.

5. The optical system of claim 1 further comprising imaging optics interposed between the dispersing element and the filter device for imaging photons from the dispersing element onto the filter device.

6. The optical system of claim 1 wherein the filter device is further defined as an order sorting filter device.

7. The optical system of claim 1 wherein the image plane is further defined as a focal plane assembly.

8. The optical system of claim 1 is operable in a mid-wave infrared wavelength band and a long-wave infrared wavelength band.

9. A dual band spectrometer, comprising:
an input aperture receiving scene photons;
an entrance slit illuminated by the photons from the input aperture;
a diffraction grating receiving photons passing through the entrance slit and operable to disperse the photons into a plurality of spectral bands, where at least one of the spectral bands embodies two diffraction orders;
a collimator interposed between the entrance slit and the diffraction grating for collimating the photons from the input aperture and directing the photons toward the diffraction grating;
an image plane receiving the at least one spectral band from the diffraction grating; and
a filter device interposed between the diffraction grating and the image plane, the filter device receiving the at least one spectral band and operable to pass only one of the diffraction orders embodied in the spectral band onto the image plane.

10. The dual band spectrometer of claim 9 further comprising fore optics interposed between the input aperture and the entrance slit for imaging photons onto the sourco slit.

11. The dual band spectrometer of claim 9 further comprising imaging optics interposed between the diffraction grating and the filter device for imaging photons from the diffraction grating onto the filter device.

12. The dual band spectrometer of claim 9 wherein the filter device is further defined as an order sorting filter.

13. The dual band spectrometer of claim 9 wherein the image plane is further defined as a focal plane assembly.

14. The dual band spectrometer of claim 9 is operable in either a mid-wave infrared wavelength band and a long-wave infrared wavelength band.
